(19) United States
(12) Patent Application Publication
(10) Pub. No.: US 2026/0123688 A1
(43) Pub. Date: May 7, 2026

(54) AEROSOL-GENERATING DEVICE HAVING PREHEATING PROFILE

(71) Applicant: KT&G CORPORATION, Daejeon (KR)

(72) Inventors: Yong Hwan KIM, Gyeonggi-do (KR); Wang Seop LIM, Gyeonggi-do (KR); Seok Su JANG, Daejeon (KR); Young Bum KWON, Gyeonggi-do (KR); Dong Sung KIM, Seoul (KR); Hwi Kyeong AN, Seoul (KR)

(73) Assignee: KT&G CORPORATION, Daejeon (KR)

(21) Appl. No.: 19/117,443

(22) PCT Filed: Jul. 8, 2024
(86) PCT No.: PCT/KR2024/009714

§ 371 Date: Apr. 1, 2025

(30) Foreign Application Priority Data
Jul. 14, 2023 (KR) 10-2023-0092052
Sep. 27, 2023 (KR) 10-2023-0130736

(51) Int. Cl. A24F 40/57; A24F 40/20; A24F 40/465; A24F 40/51; A24F 40/53; A24F 40/60

(52) U.S. Cl. CPC A24F 40/57; A24F 40/465; A24F 40/51; A24F 40/53; A24F 40/60; A24F 40/20

(57) ABSTRACT

An aerosol-generating device may include a heater configured to heat an aerosol-generating article, a power source for supplying power to the heater, and a controller configured to control power supplied from the power source to the heater so that the temperature of the heater is controlled based on a temperature profile. The temperature profile may include a preheating profile and a smoking profile. The preheating profile may include a first period in which the temperature of the heater rises to a first temperature, a second period in which the temperature of the heater drops to a second temperature lower than the first temperature, and a third period in which the temperature of the heater rises again to a third temperature higher than the second temperature.

### TECHNICAL FIELD

The disclosure relates to an aerosol-generating device having a preheating profile.

### BACKGROUND ART

There is an increasing demand for aerosol generating devices that generate aerosols via non-combustion methods instead of methods of generating aerosols by burning cigarettes. Aerosol generating devices refer to, for example, devices that perform functions of generating aerosols from aerosol generating materials in a non-combustion method and providing the aerosols to users or generating aerosols having flavors by passing a vapor generated from aerosol generating materials through flavor media.

Generating aerosols by heating solid aerosol-generating materials such as cigarettes may require more heat energy than generating aerosols by heating liquid aerosol-generating materials. Therefore, in aerosol-generating devices generating aerosols by heating solid aerosol-generating materials, it is common to preheat aerosol-generating articles at a high temperature prior to smoking in order to transfer a sufficient amount of aerosols from the beginning of smoking. However, when a larger amount of aerosols than necessary is transferred at the beginning of smoking due to excessive preheating, the continuity of aerosol transfer may not be maintained at the end of smoking. Therefore, a preheating technique capable of maintaining the aerosol transfer amount as uniform as possible throughout the entire smoking process may be required.

### DISCLOSURE OF INVENTION

### Technical Problem

Various embodiments of the present disclosure relate to an aerosol-generating device having a preheating profile. When a preheating profile includes only a temperature rising period, as a larger amount of aerosols than necessary is transferred at the beginning of smoking, the continuity of aerosol transfer may not be maintained at the end of smoking. Various embodiments provide an aerosol-generating device having a preheating profile capable of maintaining the aerosol transfer amount as uniform as possible throughout the entire smoking process.

Problems to be solved through embodiments of the disclosure are not limited to the above-described problems, and problems not mentioned may be clearly understood by one of ordinary skill in the art to which the embodiments belong from the description and accompanying drawings.

### Solution to Problem

According to an embodiment, an aerosol-generating device may include a heater configured to heat an aerosol-generating article, a power source for supplying power to the heater, and a controller configured to control power supplied from the power source to the heater so that the temperature of the heater is controlled based on a temperature profile, the temperature profile may include a preheating profile and a smoking profile, and the preheating profile may include a first period in which the temperature of the heater rises to a first temperature, a second period in which the temperature of the heater drops to a second temperature lower than the first temperature, and a third period in which the temperature of the heater rises again to a third temperature higher than the second temperature.

### Advantageous Effects of Invention

An aerosol-generating device according to various embodiments of the present disclosure may have a preheating profile including three or more periods. For example, the preheating profile according to the present disclosure may include a first period in which the temperature of the heater rises to a first temperature, a second period in which the temperature of the heater drops to a second temperature lower than the first temperature, and a third period in which the temperature of the heater rises again to a third temperature higher than the second temperature. After an aerosol is generated in the first period, the aerosol generated in the first period may be condensed in the second period, and an aerosol may be generated again in the third period.

In the third period, as the condensed aerosol is transferred again with the generation of a new aerosol, an appropriate amount of aerosols may be generated at the beginning of smoking even though the third temperature is not higher than the first temperature. In addition, the volume of heat transmitted to the aerosol-generating article is reduced due to the second period, and thus the aerosol transfer amount may be maintained uniformly until the end of smoking.

In addition, the aerosol-generating device according to the present disclosure may achieve a uniform aerosol transfer throughout the smoking period while adjusting only the preheating profile corresponding to a preheating period much shorter than a smoking period. Therefore, the uniform aerosol transfer throughout the smoking period may be achieved while minimizing power consumption compared to adjusting the smoking profile corresponding to the smoking period (e.g., increasing the temperature of the heater at the latter half of the smoking period).

Problems to be solved through embodiments of the disclosure are not limited to the above-described problems, and problems not mentioned may be clearly understood by one of ordinary skill in the art to which the embodiments belong from the description and accompanying drawings.

### BRIEF DESCRIPTION OF DRAWINGS

FIG. 1 is a block diagram of an aerosol generating device according to an embodiment.

FIG. 2 is a diagram illustrating an aerosol-generating device according to an embodiment of the present disclosure.

FIG. 3 is a diagram illustrating an aerosol-generating device according to another embodiment of the present disclosure.

FIG. 4 is a front perspective view of an aerosol-generating device according to an embodiment of the present disclosure.

FIG. 5 is a rear perspective view of an aerosol-generating device according to an embodiment of the present disclosure.

FIG. 6 is a rear exploded perspective view of an internal structure according to an embodiment of the present disclosure.

FIG. 7 is a cross-sectional view of an aerosol-generating device according to an embodiment of the present disclosure.

FIG. 8 is a perspective view of an aerosol-generating device including a susceptor and a temperature sensor according to an embodiment of the present disclosure.

FIG. 9 is a diagram illustrating a temperature profile of an aerosol-generating device according to an embodiment of the present disclosure.

FIG. 10 is a diagram illustrating a preheating profile according to an embodiment of the present disclosure.

FIG. 11 is a diagram illustrating a preheating profile according to another embodiment of the present disclosure.

FIG. 12 is a diagram for explaining effects of a preheating profile according to embodiments of the present disclosure.

FIG. 13 is a diagram for explaining a method, performed by an aerosol-generating device, of adjusting preheating profiles according to an embodiment of the present disclosure.

FIGS. 14 and 15 are diagrams illustrating target temperature profiles alternatively representing preheating profiles according to embodiments of the present disclosure.

### BEST MODE FOR CARRYING OUT THE INVENTION

According to an embodiment, an aerosol-generating device may include a heater configured to heat an aerosol-generating article, a power source for supplying power to the heater, and a controller configured to control power supplied from the power source to the heater so that the temperature of the heater is controlled based on a temperature profile, the temperature profile may include a preheating profile and a smoking profile, and the preheating profile may include a first period in which the temperature of the heater rises to a first temperature, a second period in which the temperature of the heater drops to a second temperature lower than the first temperature, and a third period in which the temperature of the heater rises again to a third temperature higher than the second temperature.

The first temperature may correspond to a range value in which a certain margin is applied to a target temperature, and the controller may variably determine the second temperature and the third temperature based on a temperature that the heater actually reaches in the first period.

The controller may determine the second temperature as a temperature obtained by subtracting a first value from the temperature that the heater actually reaches in the first period, and determine the third temperature as a temperature obtained by adding a second value to the second temperature.

The controller may increase the first value and the second value when the temperature of the heater does not reach the first temperature within a first preset time in the first period.

The second temperature may correspond to a temperature at which no aerosol is generated from the aerosol-generating article.

For example, the second temperature may be a temperature lower than all target temperatures set by the smoking profile which starts when the preheating profile ends. However, the second temperature is not necessarily limited thereto.

The controller may rise the temperature of the heater by using a proportional integral derivative (PID) control in the first period and the third period, and drop the temperature of the heater by cutting off the power supplied from the power source to the heater in the second period.

The aerosol-generating device may further include a temperature sensor for measuring the temperature of the heater, and the controller may determine a control parameter according to the PID control based on the temperature measured by the temperature sensor, and the control parameter may include a duty ratio of a pulse width modulation (PWM) signal for driving the heater.

The third period may further include a temperature drop period in which the temperature of the heater drops back to a fourth temperature after reaching the third temperature, and a temperature maintenance period in which the temperature of the heater is maintained at the fourth temperature.

A target temperature of the temperature maintenance period may be fixed regardless of the temperature that the heater actually reaches in the first period.

The controller may cut off the power supplied from the power source to the heater when the temperature of the heater does not reach a temperature lower limit by a first preset time in the first period or when the temperature of the heater reaches the first temperature within a second preset time in the first period.

The aerosol-generating device may further include an output unit configured to output information about a state of the aerosol-generating device, and the controller may control the output unit to notify an occurrence of an error state when the temperature of the heater does not drop to the second temperature by a third preset time in the second period.

The aerosol-generating device may further include a button for receiving a user input or a sensor for identifying a type of the aerosol-generating article, and the controller may adjust the first temperature based on a signal received from the button or the sensor. The aerosol-generating device may further include an insertion detection sensor for detecting insertion and/or removal of the aerosol-generating article, and the controller may start a heating operation of the heater according to the temperature profile when the insertion of the aerosol-generating article is detected by the insertion detection sensor.

The aerosol-generating device may further include an induction coil surrounding the heater, and the heater may include a susceptor generating heat by a magnetic field generated by the induction coil.

### Mode for the Invention

Hereinafter, embodiments will be described in detail with reference to the accompanying drawings, and the same or similar components will be assigned the same reference numerals regardless of the reference numerals in the drawings, and the same descriptions thereof will be omitted.

The suffixes “module”, “unit”, “-er”, and “-or” for the components used in the following description are given or used interchangeably by considering only the ease of writing the description, and do not have distinct meanings or roles in themselves.

In addition, when describing the embodiments of the disclosure, the detailed description of the related known art, which may obscure the subject matter of the embodiments, may be omitted. Also, the accompanying drawings are only intended to facilitate understanding of the embodiments described herein, and the spirit of the disclosure is not limited by the accompanying drawings and should be understood to include all changes, equivalents or alternatives included in the spirit and scope of the disclosure.

Although the terms first, second, etc. may be used herein to describe various elements or components, these elements or components should not be limited by these terms. These terms are only used to distinguish one element or component from another element or component.

When an element is referred to as being “connected to” or “coupled to” another element, it may be directly connected or coupled to the other element or intervening elements may be present. In contrast, when an element is referred to as being “directly connected to” or “directly coupled to” another element, there are no intervening elements present.

The singular forms are intended to include the plural forms as well, unless the context clearly indicates otherwise.

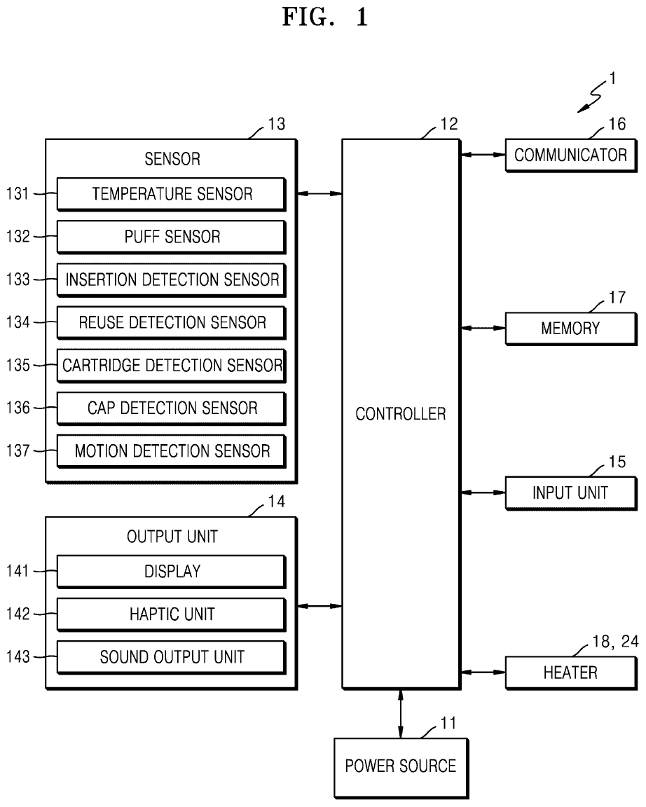

FIG. 1 is a block diagram of an aerosol generating device 1 according to an embodiment.

The aerosol generating device 1 may include a power source 11, a controller 12, a sensor 13, an output unit 14, an input unit 15, a communicator 16, a memory 17, and at least one heater 18 and 24. However, an internal structure of the aerosol generating device 1 is not limited to that illustrated in FIG. 1. In other words, according to the design of the aerosol generating device 1, one of ordinary skill in the art related to the present embodiment that some of the components shown in FIG. 1 may be omitted or new components may be added.

The sensor 13 may detect a state of the aerosol generating device 1 or a state around the aerosol generating device 1 and transmit detected information to the controller 12. On the basis of the detected information, the controller 12 may control the aerosol generating device 1 to perform various functions such as control of operations of the cartridge heater 24 and/or the heater 18, a restriction on smoking, determination of whether or not the stick S and/or the cartridge 19 are inserted, and a notification display.

The sensor 13 may include at least one of a temperature sensor 131, a puff sensor 132, an insertion detection sensor 133, a reuse detection sensor 134, a cartridge detection sensor 135, a cap detection sensor 136, and a motion detection sensor 137.

The temperature sensor 131 may detect a temperature at which the cartridge heater 24 and/or the heater 18 are heated. The aerosol generating device 1 may include a separate temperature sensor for detecting the temperatures of the cartridge heater 24 and/or the heater 18, or the cartridge heater 24 and/or the heater 18 may operate as temperature sensors.

The temperature sensor 131 may output a signal corresponding to the temperature of the cartridge heater 24 and/or the heater 18. For example, the temperature sensor 131 may include a resistor element whose resistance value changes in correspondence to a change in the temperature of the cartridge heater 24 and/or the heater 18. The temperature sensor 131 may be implemented by a thermistor or the like, which is an element using a property of changing resistance according to temperature. Here, the temperature sensor 131 may output a signal corresponding to the resistance value of the resistor element as a signal corresponding to the temperature of the cartridge heater 24 and/or the heater 18. For example, the temperature sensor 131 may include a sensor that detects a resistance value of the cartridge heater 24 and/or the heater 18. Here, the temperature sensor 131 may output a signal corresponding to the resistance value of the cartridge heater 24 and/or the heater 18 as a signal corresponding to the temperature of the cartridge heater 24 and/or the heater 18.

The temperature sensor 131 may be arranged around the power source 11 to monitor a temperature of the power source 11. The temperature sensor 131 may be arranged adjacent to the power source 11. For example, the temperature sensor 131 may be attached to one surface of a battery that is the power source 11. For example, the temperature sensor 131 may be mounted on one surface of a PCB (Printed Circuit Board).

The temperature sensor 131 may be arranged inside the body 10 to detect an internal temperature of the body 10.

The puff sensor 132 may detect a puff by a user on the basis of various physical changes in an air flow path. The puff sensor 132 may output a signal corresponding to the puff. For example, the puff sensor 132 may be a pressure sensor. The puff sensor 132 may output a signal corresponding to internal pressure of the aerosol generating device 1. Here, the internal pressure of the aerosol generating device 1 may correspond to pressure of the air flow path through which a gas flows. The puff sensor 132 may be arranged in correspondence to the air flow path through which the gas flows in the aerosol generating device 1.

The insertion detection sensor 133 may detect insertion and/or removal of the stick S. The insertion detection sensor 133 may detect a signal change due to the insertion and/or removal of the stick S. The insertion detection sensor 133 may be installed around an insertion space. The insertion detection sensor 133 may detect the insertion and/or removal of the stick S according to a change in a dielectric constant inside the insertion space. For example, the insertion detection sensor 133 may be an inductive sensor and/or a capacitance sensor.

The inductive sensor may include at least one coil. The coil of the inductive sensor may be arranged adjacent to the insertion space. For example, when a magnetic field changes around the coil through which a current flows, characteristics of the current flowing through the coil may change according to Faraday's law of electromagnetic induction. Here, the characteristics of the current flowing through the coil may include a frequency of an alternating current, a current value, a voltage value, an inductance value, an impedance value, and the like.

The inductive sensor may output a signal corresponding to the characteristics of the current flowing through the coil. For example, the inductive sensor may output a signal corresponding to an inductance value of the coil.

The capacitance sensor may include a conductor. The conductor of the capacitance sensor may be arranged adjacent to the insertion space. The capacitance sensor may output a signal corresponding to an ambient electromagnetic characteristic, e.g., a capacitance around the conductor. For example, when the stick S including a metal wrapper is inserted into the insertion space, the electromagnetic characteristic around the conductor may be changed by the wrapper of the stick S.

The reuse detection sensor 134 may detect whether or not the stick S is reused. The reuse detection sensor 134 may be a color sensor. The color sensor may detect a color of the stick S. The color sensor may detect a color of a portion of the wrapper wrapping the outside of the stick S. The color sensor may detect a value for an optical characteristic corresponding to a color of an object, on the basis of light reflected from the object. For example, the optical characteristic may be a wavelength of light. The color sensor may be implemented as a single component with a proximity sensor or may be implemented as a separate component distinguished from the proximity sensor.

At least a portion of the wrapper constituting the stick S may have a color changing by an aerosol. When the stick S is inserted into the insertion space, the reuse detection sensor 134 may be arranged in correspondence to a location at which at least the portion of the wrapper whose color changes by the aerosol is arranged. For example, before the stick S is used by the user, the color of at least the portion of the wrapper may be a first color. Here, when at least the portion of the wrapper is wetted by the aerosol while the aerosol generated by the aerosol generating device 1 passes through the stick S, the color of at least the portion of the wrapper may be changed to a second color. The color of at least the portion of the wrapper may be maintained in the second color after changing from the first color to the second color.

The cartridge detection sensor 135 may detect mounting and/or removal of the cartridge 19. The cartridge detection sensor 135 may be implemented by an inductance-based sensor, a capacitive sensor, a resistance sensor, a hall sensor (a hall IC) using a hall effect, or the like.

The cap detection sensor 136 may detect mounting and/or removal of a cap. When the cap is detached from the body 10, a portion of the cartridge 19 and the body 10 covered by the cap may be exposed to the outside. The cap detection sensor 136 may be implemented by a contact sensor, a hall sensor (a hall IC), an optical sensor, or the like.

The motion detection sensor 137 may detect a motion of the aerosol generating device 1. The motion detection sensor 137 may be implemented as at least one of an acceleration sensor and a gyro sensor.

In addition to the sensors 131 to 137 described above, the sensor 13 may further include at least one of a humidity sensor, an atmospheric pressure sensor, a magnetic sensor, a position sensor (e.g., a global positioning system (GPS)), and a proximity sensor. Functions of the respective sensors may be intuitively inferred from names thereof by one of ordinary skill in the art, and thus, detailed descriptions thereof may be omitted.

The output unit 14 may output information regarding the state of the aerosol generating device 1 and provide the information to the user. The output unit 14 may include at least one of a display 141, a haptic unit 142, and a sound output unit 143, but is not limited thereto. When the display 141 and a touch pad form a layer structure to form a touch screen, the display 141 may be used as an input device in addition to an output device.

The display 141 may visually provide the user with information regarding the aerosol generating device 1. For example, the information regarding the aerosol generating device 1 may refer to various types of information such as a charging/discharging state of the power source 11 of the aerosol-generating device 1, a preheating state of the heater 18, the insertion/removal state of the stick S and/or the cartridge 19, the mounting/removal state of the cap, and the restriction on use of the aerosol generating device 1 (e.g., detection of an abnormal article), and the display 141 may output the information to the outside. For example, the display 141 may be in the form of a light emitting diode (LED) light emitting device. For example, the display 141 may be a liquid crystal display (LCD) panel, an organic light emitting display (OLED) panel, or the like.

The haptic unit 142 may tactilely provide the user with the information regarding the aerosol generating device 1 by converting an electrical signal into a mechanical stimulus or an electrical stimulus. For example, when initial power is supplied to the cartridge heater 24 and/or the heater 18 for a set time, the haptic unit 142 may generate vibration corresponding to completion of initial preheating. The haptic unit 142 may include a vibration motor, a piezoelectric element, or an electrical stimulation device.

The sound output unit 143 may audibly provide the user with the information regarding the aerosol generating device 1. For example, the sound output unit 143 may convert the electrical signal into a sound signal and output the sound signal to the outside.

The power supply 11 may supply power used to operate the aerosol generating device 1. The power source 11 may supply power so that the cartridge heater 24 and/or the heater 18 may be heated. In addition, the power source 11 may supply power needed for operations of the sensor 13, the output unit 14, the input unit 15, the communicator 16, and the memory 17, which are other components provided within the aerosol generating device 1. The power source 11 may be a rechargeable battery or a disposable battery. For example, the power supply 11 may be a lithium polymer (LiPoly) battery, but is not limited thereto.

Although not shown in FIG. 1, the aerosol generating device 1 may further include a power protection circuit. The power protection circuit may be electrically connected to the power source 11 and may include a switching element.

The power protection circuit may cut off an electrical path for the power source 11 according to a certain condition. For example, the power protection circuit may cut off the electrical path for the power source 11 when a voltage level of the power source 11 is a first voltage or more corresponding to overcharging. For example, the power protection circuit may cut off the electrical path for the power source 11 when the voltage level of the power source 11 is less than a second voltage corresponding to overdischarge.

The heater 18 may be supplied with power from the power source 11 and heat a medium or an aerosol generating material within the stick S. Although not shown in FIG. 1, the aerosol generating device 1 may further include a power conversion circuit (e.g., a DC/DC converter) that converts power of the power source 11 and supplies the converted power to the cartridge heater 24 and/or the heater 18. In addition, when the aerosol generating device 1 generates an aerosol by an induction heating method, the aerosol generating device 1 may further include a DC/AC converter that converts DC power of the power source 11 into AC power.

The controller 12, the sensor 13, the output unit 14, the input unit 15, the communicator 16, and the memory 17 may be supplied with power from the power source 11 to perform functions. Although not shown in FIG. 1, the aerosol generating device 1 may further include a power conversion circuit that converts power of the power source 11 and supplies the power to each of components, e.g., a low-dropout (LDO) circuit or a voltage regulator circuit. Also, although not shown in FIG. 1, a noise filter may be provided between the power source 11 and the heater 18. The noise filter may be a low pass filter. The low pass filter may include at least one inductor and a capacitor. A cutoff frequency of the low pass filter may correspond to a frequency of a high-frequency switching current applied from the power source 11 to the heater 18. The low pass filter may prevent a high-frequency noise component from being applied to the sensor 13, such as the insertion detection sensor 133.

In an embodiment, the cartridge heater 24 and/or the heater 18 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, or nichrome, but is not limited thereto. In addition, the heater 18 may be implemented by a metal wire, a metal plate on which an electrically conductive track is arranged, or a ceramic heating element, but is not limited thereto.

In an embodiment, the heater 18 may include an induction heater. For example, the heater 18 may include a susceptor that generates heat through a magnetic field applied by a coil to heat an aerosol generating material.

The input unit 15 may receive information input from the user or output the information to the user. For example, the input unit 15 may be a touch panel. The touch panel may include at least one touch sensor for detecting a touch. For example, the touch sensor may include a capacitive touch sensor, a resistive touch sensor, a surface acoustic touch sensor, an infrared touch sensor, or the like, but is not limited thereto.

The display 141 and the touch panel may be implemented as one panel. For example, the touch panel may be inserted into the display 141 (e.g., may be a on-cell type or in-cell type). For example, the touch panel may be added on the display 141 (e.g., may be an add-on type).

Meanwhile, the input unit 15 may include a button, a keypad, a dome switch, a jog wheel, a jog switch, or the like, but is not limited thereto.

The memory 17 may be hardware for storing various types of data processed within the aerosol generating device 1 and may store pieces of data processed by the controller 12 and pieces of data to be processed by the controller 12. The memory 17 may include at least one type of storage medium from among a flash memory type, a hard disk type, a multimedia card micro type, a card type memory (e.g., a SD or XD memory or the like), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 17 may store data or the like regarding an operation time of the aerosol generating device 1, the maximum number of puffs, the current number of puffs, at least one temperature profile, and a smoking pattern of the user.

The communicator 16 may include at least one component for communication with another electronic device. For example, the communicator 16 may include at least one of a short-range wireless communication unit and a wireless communication unit.

The short-range wireless communication unit may include a Bluetooth communication unit, a Bluetooth low energy (BLE) communication unit, a near field communication unit, a wireless local area network ((WLAN) (Wi-Fi)) communication unit, a Zigbee communication unit, an infrared data association (IrDA) communication unit, a Wi-Fi Direct (WFD) communication unit, an ultra wideband (UWB) communication unit, an Ant+ communication unit, and the like, but is not limited thereto.

The wireless communication unit may include a cellular network communication unit, an Internet communication unit, a computer network (e.g., LAN or WAN) communication unit, and the like, but is not limited thereto.

Although not shown in FIG. 1, the aerosol generating device 1 may further include a connection interface such as a universal serial bus (USB) interface, and may connect with another external device through the connection interface such as a USB interface to transmit and receive information or charge the power source 11.

The controller 12 may control an overall operation of the aerosol generating device 1. In an embodiment, the controller 12 may include at least one processor. The processor may be implemented as an array of a plurality of logic gates or may be implemented as a combination of a general-purpose microprocessor and a memory that stores a program executable by the microprocessor. In addition, one of ordinary skill in the art to which the present embodiment pertains may understand that the processor may be implemented as other types of hardware.

The controller 12 may control the temperature of the heater 18 by controlling supply power from the power source 11 to the heater 18. The controller 12 may control the temperature of the cartridge heater 24 and/or the heater 18 on the basis of the temperature of the cartridge heater 24 and/or the heater 18 sensed by the temperature sensor 131. The controller 12 may adjust power supplied to the cartridge heater 24 and/or the heater 18, on the basis of the temperature of the cartridge heater 24 and/or the heater 18. For example, the controller 12 may determine a target temperature for the cartridge heater 24 and/or the heater 18, on the basis of a temperature profile stored in the memory 17.

The aerosol generating device 1 may include a power supply circuit (not shown) electrically connected to the power source 11 between the power source 11 and the cartridge heater 24 and/or the heater 18. The power supply circuit may be electrically connected to the cartridge heater 24, the heater 18, or an induction coil. The power supply circuit may include at least one switching element. The switching element may be implemented by a bipolar junction transistor (BJT), a field effective transistor (FET), or the like. The controller 12 may control the power supply circuit.

The controller 12 may control power supply by controlling switching of the switching element of the power supply circuit. The power supply circuit may be an inverter that converts DC power output from the power source 11 into AC power. For example, the inverter may include a full-bridge circuit or a half-bridge circuit including a plurality of switching elements.

The controller 12 may turn on the switching element so that power is supplied from the power source 11 to the cartridge heater 24 and/or the heater 18. The controller 12 may turn off the switching element to cut off the supply of power to the cartridge heater 24 and/or the heater 18. The controller 12 may adjust a current supplied from the power source 11 by adjusting a frequency and/or duty ratio of a current pulse input into the switching element.

The controller 12 may control a voltage output from the power source 11 by controlling switching of the switching element of the power supply circuit. The power conversion circuit may convert the voltage output from the power source 11. For example, the power conversion circuit may include a buck-converter that steps down the voltage output from the power source 11. For example, the power conversion circuit may be implemented through a buck-boost converter, a zener diode, or the like.

The controller 12 may adjust a level of the voltage output from the power conversion circuit by controlling an on/off operation of the switching element included in the power conversion circuit. When the switching element continues to be turned on, the level of the voltage output from the power conversion circuit may correspond to a level of a voltage output from the power source 11. The duty ratio for the on/off operation of the switching element may correspond to a ratio of the voltage output from the power conversion circuit to the voltage output from the power source 11. The level of the voltage output from the power conversion circuit may decrease with a decrease in the duty ratio for the on/off operation of the switching element. The heater 18 may be heated on the basis of the voltage output from the power conversion circuit.

The controller 12 may control power to be supplied to the heater 18 by using at least one of a pulse width modulation (PWM) method and a proportional-integral-differential (PID) method.

For example, the controller 12 may control a current pulse having a certain frequency and duty ratio to be supplied to the heater 18 by using the PWM method. The controller 12 may control the power supplied to the heater 18 by adjusting the frequency and duty ratio of the current pulse.

For example, the controller 12 may determine a target temperature to be controlled, on the basis of the temperature profile. The controller 12 may control the power supplied to the heater 18 by using the PID method, which is a feedback control method through a difference value between the temperature of the heater 18 and the target temperature, a value obtained by integrating the difference value over time, and a value obtained by differentiating the difference value over time.

The controller 12 may prevent the cartridge heater 24 and/or the heater 18 from overheating. For example, on the basis that the temperature of the cartridge heater 24 and/or the heater 18 exceeds a preset limit temperature, the controller 12 may control an operation of the power conversion circuit so that the supply of power to the cartridge heater 24 and/or the heater 18 stops. For example, on the basis that the temperature of the cartridge heater 24 and/or the heater 18 exceeds the preset limit temperature, the controller 12 may reduce an amount of power supplied to the cartridge heater 24 and/or the heater 18 by a certain ratio. For example, on the basis that the temperature of the cartridge heater 24 exceeds the preset limit temperature, the controller 12 may determine that the aerosol generating material accommodated in the cartridge 19 is exhausted and cut off the power supply to the cartridge heater 24.

The controller 12 may control charging and discharging of the power source 11. The controller 12 may identify the temperature of the power source 11 on the basis of an output signal of the temperature sensor 131.

When a power line is connected to a battery terminal of the aerosol generating device 1, the controller 12 may identify whether or not the temperature of the power source 11 is a first limit temperature or more which is a reference for blocking charging of the power source 11. When the temperature of the power source 11 is less than the first limit temperature, the controller 12 may control the power source 11 to be charged, on the basis of a preset charging current. The controller 12 may block charging of the power source 11 when the temperature of the power source 11 is the first limit temperature or more.

While the power of the aerosol generating device 1 is turned on, the controller 12 may identify whether or not the temperature of the power source 11 is a second limit temperature or more which is a reference for blocking discharge of the power source 11. The controller 12 may control power stored in the power source 11 to be used when the temperature of the power source 11 is less than the second limit temperature. When the temperature of the power source 11 is the second limit temperature or more, the controller 12 may stop using the power stored in the power source 11.

The controller 12 may calculate a remaining capacity of the power stored in the power source 11. For example, the controller 12 may calculate the remaining capacity of the power source 11 on the basis of a voltage and/or current sensing value of the power source 11.

The controller 12 may determine, through the insertion detection sensor 133, whether or not the stick S is inserted into the insertion space. The controller 12 may determine that the stick S is inserted, on the basis of the output signal of the insertion detection sensor 133. When determining that the stick S is inserted into the insertion space, the controller 12 may control power to be supplied to the cartridge heater 24 and/or the heater 18. For example, the controller 12 may supply power to the cartridge heater 24 and/or the heater 18, on the basis of the temperature profile stored in the memory 17.

The controller 12 may determine whether or not the stick S is removed from the insertion space. For example, the controller 12 may determine, through the insertion detection sensor 133, whether or not the stick S is removed from the insertion space. For example, when the temperature of the heater 18 is the preset limit temperature or more or when a temperature change gradient of the heater 18 is a set gradient, the controller 12 may determine that the stick S is removed from the insertion space. When determining that the stick S is removed from the insertion space, the controller 12 may cut off the supply of power to the cartridge heater 24 and/or the heater 18.

The controller 12 may control a power supply time and/or a power supply amount with respect to the heater 18, according to a state of the stick S detected by the sensor 13. The controller 12 may identify, on the basis of a look-up table, a level range including a level of a signal of the capacitance sensor. The controller 12 may determine an amount of moisture in the stick S, according to the identified level range.

When the stick S is over-humidified, the controller 12 may increase a preheating time of the stick S compared to a normal state by controlling the power supply time with respect to the heater 18.

The controller 12 may determine, through the reuse detection sensor 134, whether or not the stick S inserted into the insertion space is reused. For example, the controller 12 may compare a sensing value of a signal of the reuse detection sensor 134 with a first reference range including a first color and when the sensing value is included in the first reference range, determine that the stick S is not used. For example, the controller 12 may compare the sensing value of the signal of the reuse detection sensor 134 with a second reference range including a second color and when the sensing value is included in the second reference range, determine that the stick S is used. When determining that the stick S is used, the controller 12 may cut off the supply of power to the cartridge heater 24 and/or the heater 18.

The controller 12 may determine, through the cartridge detection sensor 135, whether or not the cartridge 19 is coupled and/or removed. For example, the controller 12 may determine whether or not the cartridge 19 is coupled or removed, on the basis of a sensing value of the signal of the cartridge detection sensor 135.

The controller 12 may determine whether or not the aerosol generating material of the cartridge 19 is exhausted. For example, the controller 12 may apply power to preheat the cartridge heater 24 and/or the heater 18, determine whether or not the temperature of the cartridge heater 24 exceeds the limit temperature in a preheating period, and when the temperature of the cartridge heater 24 exceeds the limit temperature, determine that the aerosol generating material of the cartridge 19 is exhausted. When determining that the aerosol generating material of the cartridge 19 is exhausted, the controller 12 may cut off the supply of power to the cartridge heater 24 and/or the heater 18.

The controller 12 may determine whether or not the cartridge 19 may be usable. When the current number of puffs is greater than or equal to the maximum number of puffs set in the cartridge 19, the controller 12 may determine, on the basis of data stored in the memory 17, that the cartridge 19 may not be usable. For example, when the total time for which the heater 24 is heated is a preset maximum time or more or the total amount of power supplied to the heater 24 is a preset maximum amount of power or more, the controller 12 may determine that the cartridge 19 may not be usable.

The controller 12 may determine inhalation by the user through the puff sensor 132. For example, the controller 12 may determine whether or not a puff occurs, on the basis of a sensing value of a signal of the puff sensor 132. For example, the controller 12 may determine an intensity of the puff, on the basis of the sensing value of the signal of the puff sensor 132. When the number of puffs reaches the preset maximum number of puffs or when puffs are not detected for a preset time or more, the controller 12 may cut off the supply of power to the cartridge heater 24 and/or the heater 18.

The controller 12 may determine, through the cap detection sensor 136, whether a cap is coupled and/or removed. For example, the controller 12 may determine whether or not the cap is coupled and/or removed, on the basis of a sensing value of a signal of the cap detection sensor 136.

The controller 12 may control the output unit 14 on the basis of the result of detection by the sensor 13. For example, when the number of puffs counted through the puff sensor 132 reaches a preset number, the controller 12 may notify the user that the aerosol generating device 1 is soon terminated, through at least one of the display 141, the haptic unit 142, and the sound output unit 143. For example, the controller 12 may notify the user through the output unit 14 that the stick S is not present in the insertion space, on the basis of the determination that the stick S is not present in the insertion space. For example, the controller 12 may notify the user through the output unit 14 that the cartridge 19 and/or the cap are not mounted, on the basis of the determination that the cartridge 19 and/or the cap are not mounted. For example, the controller 12 may transmit information regarding the temperature of the cartridge heater 24 and/or the heater 18 to the user through the output unit 14.

The controller 12 may store and update, in the memory 17, a history of a certain event that occurs, on the basis of the occurrence of the event. The event may include detection of insertion of the stick S, initiation of heating of the stick S, detection of puffs, termination of the puffs, detection of overheating of the cartridge heater 24 and/or the heater 18, detection of application of an overvoltage to the cartridge heater 24 and/or the heater 18, termination of heating of the stick S, an operation such as power on/off of the aerosol generating device 1, initiation of charging of the power source 11, detection of overcharging of the power source 11, termination of charging of the power source 11, and the like. The history of the event may include a date and time when the event occurs, log data corresponding to the event, and the like. For example, when the certain event is the detection of insertion of the stick S, the log data corresponding to the event may include data regarding the sensing value of the insertion detection sensor 133 and the like. For example, when the certain event is the detection of overheating of the cartridge heater 24 and/or the heater 18, the log data corresponding to the event may include data regarding the temperature of the cartridge heater 24 and/or the heater 18, the voltage applied to the cartridge heater 24 and/or the heater 18, a current flowing through the cartridge heater 24 and/or the heater 18, and the like.

The controller 12 may control to form a communication link with an external device such as a mobile terminal of the user. When data regarding authentication is received from the external device through the communication link, the controller 12 may release a restriction on use of at least one function of the aerosol generating device 1. Here, the data regarding the authentication may include data indicating completion of user authentication for the user corresponding to the external device. The user may perform the user authentication through the external device. The external device may determine whether or not user data is valid, on the basis of the birthday of the user, a unique number indicating the user, and the like and receive, from an external server, data regarding use authority over the aerosol generating device 1. The external device may transmit the data indicating the completion of the user authentication to the aerosol generating device 1, on the basis of the data regarding the use authority. When the user authentication is completed, the controller 12 may release the restriction on the use of at least one function of the aerosol generating device 1. For example, when the user authentication is completed, the controller 12 may release a restriction on use of a heating function of supplying power to the heater 18.

The controller 12 may transmit data regarding the state of the aerosol generating device 1 to the external device through the communication link formed with the external device. On the basis of the received data regarding the state of the aerosol generating device 1, the external device may output the remaining capacity of the power source 11 of the aerosol generating device 1, an operation mode, and the like through a display of the external device.

The external device may transmit a location search request to the aerosol generating device 1, on the basis of an input for initiating a location search of the aerosol generating device 1. When receiving the location search request from the external device, the controller 12 may control at least one of output devices to perform an operation corresponding to the location search, on the basis of the received location search request. For example, the haptic unit 142 may generate vibration in response to the location search request. For example, the display 141 may output an object corresponding to the location search and an end of the search in response to the location search request.

When receiving firmware data from the external device, the controller 12 may control to perform a firmware update. The external device may identify a current version of firmware of the aerosol generating device 1 and determine whether or not a new version of the firmware is present. When an input for requesting firmware download is received, the external device may receive a new version of firmware data and transmit the new version of firmware data to the aerosol generating device 1. When receiving the new version of firmware data, the controller 12 may control the firmware update of the aerosol generating device 1 to be performed.

The controller 12 may transmit data regarding a sensing value of at least one sensor 13 to the external server (not shown) through the communicator 16, and receive from the server and store a learning model generated by learning the sensing value through machine learning such as deep learning. The controller 12 may perform an operation of determining an inhalation pattern of the user, an operation of generating a temperature profile, and the like by using the learning model received from the server. The controller 12 may store, in the memory 17, sensing value data of at least one sensor 13, data for training an artificial neural network (ANN), and the like. For example, the memory 17 may store a database for each component provided in the aerosol generating device 1, which is for training the ANN, and weights and biases constituting the structure of the ANN. The controller 12 may generate at least one learning model used for determining the inhalation pattern of the user, generating the temperature profile, and the like, by learning data regarding the sensing value of the at least one sensor 13, the inhalation pattern of the user, the temperature profile, and the like which are stored in the memory 17.

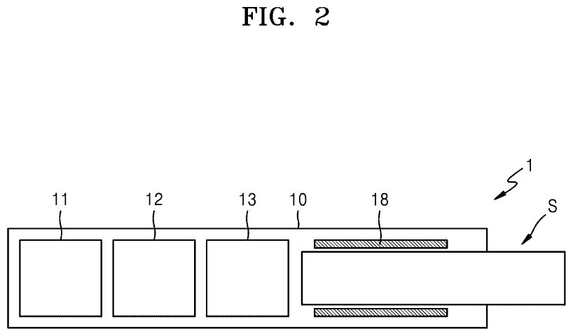

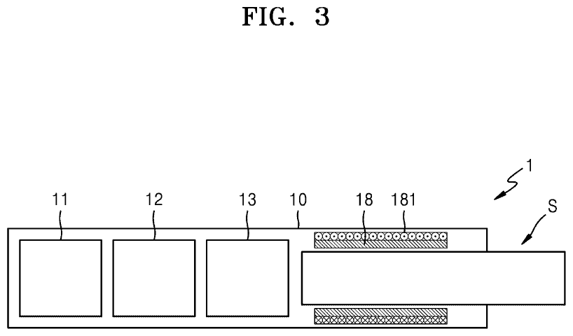

FIGS. 2 and 3 illustrate an aerosol-generating device 1 according to embodiments of the present disclosure.

Referring to FIG. 2, the aerosol-generating device 1 may include at least one of a power source 11, a controller 12, a sensor 13, or a heater 18. At least one of the power source 11, the controller 12, the sensor 13, and the heater 18 may be disposed inside a body 10 of the aerosol-generating device 1. The body 10 may provide a space opened upward to allow a stick S, which is an aerosol-generating article, to the inserted thereinto. The space opened upward may be referred to as an insertion space. The insertion space may be formed by being recessed toward the interior of the body 10 to a certain depth so that at least a part of the stick S may be inserted into the insertion space. The depth of the insertion space may correspond to a length of a region of the stick S including an aerosol-generating material and/or a medium. A lower end of the stick S may be inserted into the body 10, and an upper end of the stick S may protrude to the outside of the body 10. A user may inhale air by holding, in the mouth, the upper end of the stick S exposed to the outside.

The heater 18 may heat the stick S. The heater 18 may extend longitudinally upward around the space into which the stick S is inserted. For example, the heater 18 may be in the form of a tube including a hollow inside. The heater 18 may be disposed around the insertion space. The heater 18 may be disposed to surround at least a part of the insertion space. The heater 18 may heat the insertion space or the stick S inserted into the insertion space. The heater 18 may include an electrically resistive heater and/or an induction heater.

For example, referring to FIG. 2, the heater 18 may be a resistive heater. For example, the heater 18 may include an electrically conductive track, and be heated as a current flows through the electrically conductive track. The heater 18 may be electrically connected to the power source 11. The heater 18 may directly generate heat by receiving a current from the power source 11. The heater 18 may be a hollow shape heater disposed to surround at least a part of the stick S inserted into the insertion space to heat the outside of the inserted stick S, or may be a heater in the shape of a needle, rod, or tube inserted into the stick S inserted into the insertion space to heat the inside of the inserted stick S.

For example, referring to FIG. 3, the aerosol-generating device 1 may include an induction coil 181 surrounding the heater 18. The induction coil 181 may make the heater 18 generate heat. The heater 18, which is a susceptor, may generate heat by a magnetic field generated by an AC current flowing through the induction coil 181. The magnetic field may penetrate the heater 18 and generate an eddy current within the heater 18. The current may generate heat in the heater 18.

On the other hand, a susceptor may be included inside the stick S, and the susceptor inside the stick S may be heated by the magnetic field generated by the AC current flowing through the induction coil 181.

The power supply 11 may supply power such that the components of the aerosol-generating device 1 operate. The power source 11 may be referred to as a battery. The power supply 11 may supply power to at least one of the controller 12, the sensor 13, or the heater 18. When the aerosol-generating device 1 includes the induction coil 181, the power source 11 may supply power to the induction coil 181.

The controller 12 may control overall operations of the aerosol-generating device 1. The controller 12 may be mounted on a printed circuit board (PCB). The controller 12 may control an operation of at least one of the power source 11 or the sensor 13. The controller 12 may control the operation of the induction coil 181. The controller 12 may control operations of a display, a motor, etc. installed in the aerosol-generating device 1. The controller 12 may check a state of each of the components of the aerosol-generating device 1 to determine whether the aerosol-generating device 1 is in an operable state.

The controller 12 may analyze a result detected by the sensor 13 and control processes to be performed subsequently. For example, the controller 12 may control the power supplied to the heater 18 such that the operation of the heater 18 starts or ends based on a result detected by the sensor 13. For example, the controller 12 may control an amount of power supplied to the heater 18 and a time for which the power is supplied to the heater 18 such that the heater 18 may be heated to a certain temperature or maintained at an appropriate temperature based on the result detected by the sensor 13.

The sensor 13 may include at least one of a temperature sensor, a puff sensor, or an insertion detection sensor. For example, the sensor 13 may sense at least one of the temperature of the heater 18, the temperature of the power source 11, or the temperature inside and outside the body 10. For example, the sensor 13 may sense a puff by the user. For example, the sensor 13 may sense whether the stick S has been inserted into the insertion space.

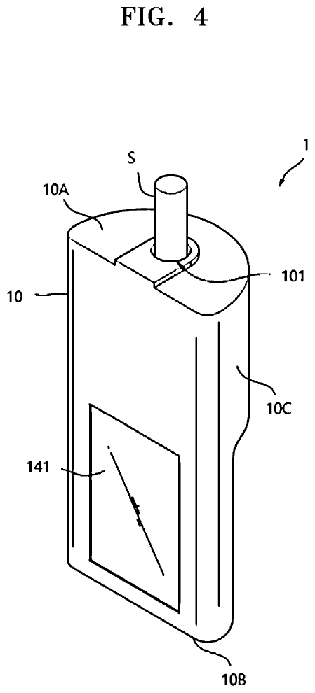

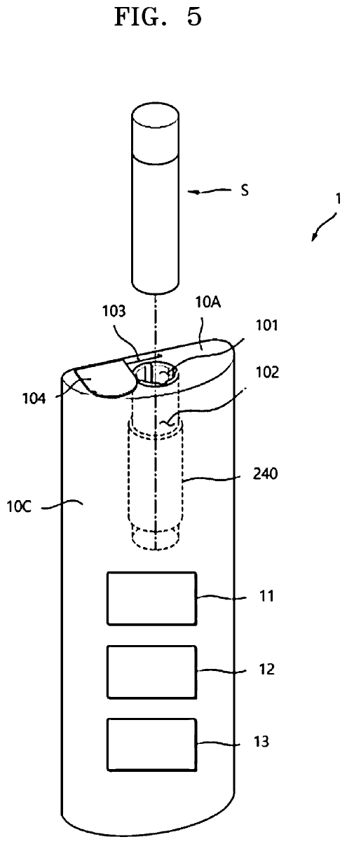

FIG. 4 is a front perspective view of an aerosol-generating device according to an embodiment of the present disclosure. FIG. 5 is a rear perspective view of an aerosol-generating device according to an embodiment of the present disclosure.

Referring to FIG. 4, the aerosol-generating device 1 according to an embodiment of the present disclosure may include at least one of the power source 11, the controller 12, or the sensor 13. At least one of the power source 11, the controller 12, or the sensor 13 may be disposed inside the body 10 of the aerosol-generating device 1. The characteristics of the power source 11, the controller 12, and the sensor 13 described above with reference to FIGS. 2 and 3 may be equally applied to the power source 11, the controller 12, and the sensor 13.

The body 10 may form the overall appearance of the aerosol-generating device 1, and include an inner space in which components of the aerosol-generating device 1 may be disposed. The drawings illustrate only an embodiment in which the body 10 has a semicircular cross section as a whole, but the shape of the body 10 is not limited thereto, and the body 10 may have a cylindrical shape or a polygonal column shape as a whole.

The body 10 may include a first body surface 10A (e.g., a body upper surface), a second body surface 10B (e.g., a body lower surface) opposite the first body surface 10A, and at least one third body surface 10C (e.g., a body side surface) between the first body surface 10A and the second body surface 10B.

Referring to FIG. 5, the body 10 may have an insertion space 102 formed therein. The insertion space 102 may be formed on an upper portion of the body 10. The insertion space 102 may be opened upward. The insertion space 102 may have a cylindrical shape extending longitudinally. At least a part of the stick S may be inserted into the body 10 through an opening 101 in an upper side of the insertion space 102. A depth of the insertion space 102 may correspond to a length of a region of the stick S including an aerosol-generating material and/or a medium.

A heater 240 (e.g., the heater 18 of FIGS. 2 and 3) may surround at least a part of the outside of the insertion space 102. The heater 240 may extend longitudinally along the insertion space 102. For example, the heater 240 may be a cylindrical electric resistive heater surrounding at least a part of the insertion space 102. For example, the heater 240 may include a cylindrical susceptor surrounding at least a part of the insertion space 102 and an induction coil surrounding the susceptor. The heater 240 may heat the outside of the stick S accommodated in the insertion space 102. At least one region of the stick S accommodated in the insertion space 102 may be heated by the heater 240, and vaporized particles generated by heating the stick S and air introduced into the inner space of the body 10 through the opening 101 may be mixed to generate an aerosol.

A display 141 may be disposed on one side of the body 10. At least a part of the display 141 may be exposed to the outside of the body 10.

The display 141 may provide a variety of visual information to a user. The display 141 may include a display panel and/or a touch panel. The display 141 may include a cover glass.

The cover glass may form the appearance of the aerosol-generating device 1 together with the body 10. The cover glass may be in contact with a part of a user's body. The cover glass may protect the display panel and/or the touch panel from an external impact.

The display panel may be disposed in a direction toward the inside of the body 10 from the cover glass. The display panel may be disposed parallel to the cover glass.

The touch panel may detect a touch corresponding to the contact of an object. For example, the touch panel may detect a touch corresponding to the contact of a part of the user's body. The touch panel may receive an input of the user.

A cover 104 may be provided on the upper side of the body 10. The cover 104 may have a shape corresponding to the shape of the opening 101 of the body 10. For example, the opening 101 of the body 10 may be circular, and the cover 104 may be circular with a larger diameter than the diameter of the opening 101.

The cover 104 may be movably connected to a guide 103 formed in the body 10. The cover 104 may move along the guide 103. For example, the guide 103 may be a groove formed in one surface of the body 10, and the cover 104 may include a protrusion that slides while being inserted into the groove of the body 10. For another example, the guide 103 may be a protrusion protruding from one surface of the body 10, and the cover 104 may include a groove inserted into the protrusion to be slid along the protrusion.

The cover 104 may open and close the opening 101 of the body 10 by moving along the guide 103. For example, the cover 104 may close the opening 101 at a first position and open the opening 101 at a second position. A position of the cover 104 may be manually moved by the user. In addition, a driving device may be provided in the aerosol-generating device 1 to move the position of the cover 104.

The body 10 may include a connection terminal (not shown). The connection terminal may include a connector through which the aerosol-generating device 1 may be physically connected to an external electronic device. For example, the connection terminal may include at least one of an HDMI connector, a USB connector, an SD card connector, or an audio connector (e.g., a headphone connector) or a combination thereof.

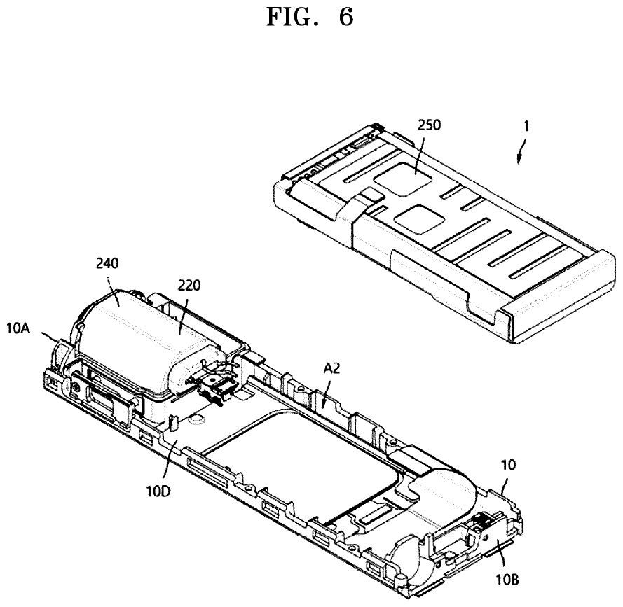

FIG. 6 is a rear exploded perspective view of an internal structure according to an embodiment of the present disclosure.

Referring to FIG. 6, the body 10 of the aerosol-generating device 1 may include a first portion. The first portion may include a part adjacent to the first body surface 10A of the body 10. The body 10 may include a second portion A2. The second portion A2 may be at least partially different from the first portion. The second portion A2 may include a part adjacent to the second body surface 10B of the body.

A power source 250 may be disposed in the second portion A2 of the body 10. The power supply 250 may include a pouch type battery. The power source 250 may be disposed adjacent to a PCB. For example, the power supply 250 may be disposed on one side of an inner surface 10D of the body 10, and the PCB may be disposed on the other side of the power supply 250 opposite to one side of the inner surface 10D. However, the arrangement of the PCB and the power source 250 is not limited thereto.

The heater 240 may be disposed in the first portion of the body 10.

A thermal insulator 220 may thermally insulate the heater 240. The thermal insulator 220 may be disposed in the first portion of the body 10. The thermal insulator 220 may surround the heater 240.

The aerosol-generating device 1 may include a buffer structure (not shown). The buffer structure may be configured to buffer the power source 250. The buffer structure may be disposed in at least a part of the inner surface 10D of the second portion A2 of the body 10. The buffer structure may reduce or prevent an impact applied to the power supply 250 when an external impact is applied to the aerosol-generating device 1.

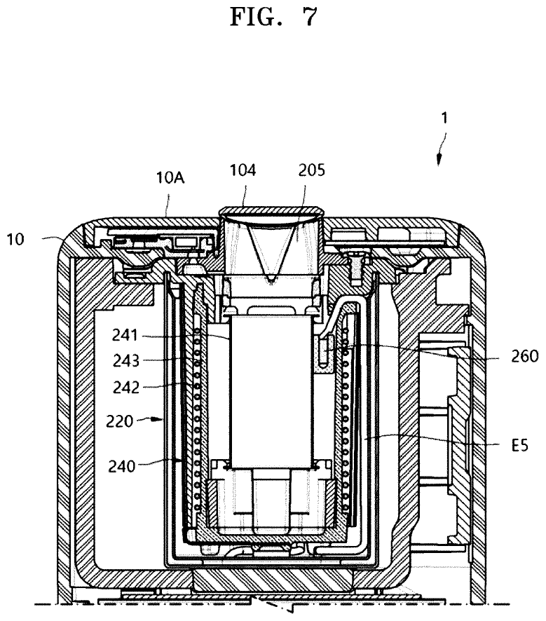

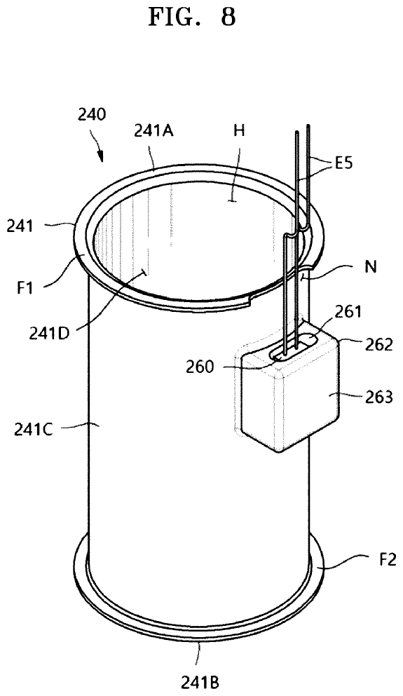

FIG. 7 is a cross-sectional view of an aerosol-generating device according to an embodiment of the present disclosure. FIG. 8 is a perspective view of an aerosol-generating device including a susceptor and a temperature sensor according to an embodiment of the present disclosure.

Referring to FIG. 7, the aerosol-generating device 1 may include an article insertion portion 205. The article insertion portion 205 may guide insertion of the stick S (see FIG. 4) to the heater 240. The article insertion portion 205 may be disposed in the first body surface 10A of the body 10.

The cover 104 may open and close the article insertion portion 205. The cover 104 may be configured to operate in a sliding manner or a hinge manner.

The heater 240 may heat the stick S. The heater 240 may include a heater housing 243. The heater housing 243 may be disposed inside the body 10.

The heater 240 may include a coil 242. The coil 242 may be disposed outside the heater housing 243. The coil 242 may be wound around the heater housing 243. The coil 242 may surround at least a part of an outer surface of the heater housing 243 and may be wound in a spiral direction in a longitudinal direction of the heater housing 243. The coil 242 may have a first connection portion (not shown) forming one end of the wound part connected to at least one electrical line, and a second connection portion (not shown) forming the other end of the wound part connected to at least one other electrical line. The coil 242 may be connected to a PCB through at least one electrical line.

The heater 240 may include a susceptor 241. The susceptor 241 may at least partially accommodate the stick S. The susceptor 241 may be configured to transmit heat to the stick S. For example, the susceptor 241 may be electromagnetically coupled to the coil 242 and generate heat.

The aerosol-generating device 1 may include a temperature sensor 260. The temperature sensor 260 may sense the temperature of the heater 240. The temperature sensor 260 may be disposed between the heater housing 243 and the susceptor 241. The temperature sensor 260 may be connected to the PCB through an electrical line E5. The temperature sensor 260 may be connected to the controller 12 (see FIG. 2) through the electrical line E5.

Referring to FIG. 8, the susceptor 241 may include a first surface 241A (e.g., an upper surface), a second surface 241B (e.g., a lower surface) opposite the first surface 241A, and a third surface 241C (e.g., a side surface) between the first surface 241A and the second surface 241B.

The first surface 241A may include a first opening H. The stick S may be inserted into the susceptor 241 through the first opening H. The first opening H may include a substantially circular or elliptical cross section.

The second surface 241B may include a second opening (not shown). The second opening may allow the passage of an end portion of the stick S inserted into the susceptor 241. The second opening may have a substantially circular or elliptical cross section.

The first surface 241A may include a first flange F1. The first flange F1 may extend from the third surface 241C in a width direction or a radial direction. The first flange F1 may at least partially extend in a circumferential direction of the first surface 241A.

The first surface 241A may include a notch N. The notch N may be formed in one region of the first flange F1. The at least one electrical line E5 may extend while penetrating at least a part of the notch N.

The second surface 241B may include a second flange F2. The second flange F2 may extend from the third surface 241C in the width direction or the radial direction. The second flange F2 may extend in a circumferential direction of the second surface 241B.

The susceptor 241 may include a body portion (i.e., the first surface 241A, the second surface 241B and the third surface 241C), and a hollow portion 241D. The hollow portion 241D may be defined inside the body portion (i.e., the first surface 241A, the second surface 241B, the third surface 241C). The hollow portion 241D may extend between the first surface 241A and the second surface 241B. The hollow portion 241D may at least partially accommodate the stick S.

The heater 240 may include a pocket 262. The pocket 262 may include a pocket body 263. The pocket body 263 may be disposed on the third surface 241C of the susceptor 241. The pocket body 263 may be seamlessly connected to the third surface 241C.

The pocket 262 may include a recess (not shown). The recess may be disposed in the pocket body 263. The recess may accommodate the temperature sensor 260.

The pocket 262 may include a sealing 261. The sealing 261 may seal the temperature sensor 260. The sealing 261 may be filled on the temperature sensor 260 and inside the recess. The sealing 261 may seal the temperature sensor 260 by filling a space between the inside of the recess and the temperature sensor 260. The sealing 261 may include an adhesive material. For example, the adhesive material may include ceramic. The sealing 261 may increase a fixing force between the temperature sensor 260 and the recess.

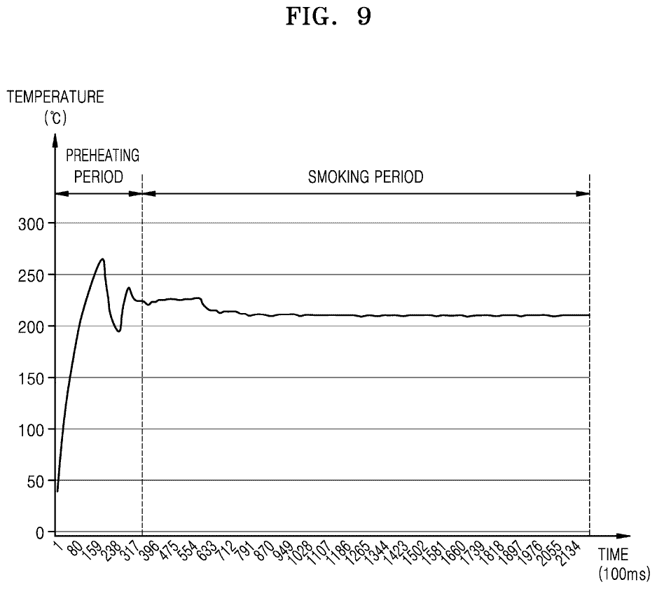

FIG. 9 is a diagram illustrating a temperature profile of an aerosol-generating device according to an embodiment of the present disclosure.

Referring to FIG. 9, it may be seen that the temperature profile is divided into a preheating period and a smoking period. The temperature profile may include a preheating profile corresponding to the preheating period and a smoking profile corresponding to the smoking period.

The aerosol-generating device may include a heater (e.g., the heater 18 of FIGS. 1 to 3 or the heater 240 of FIGS. 5 to 8) configured to heat an aerosol generating article (e.g., the stick S of FIGS. 2 and 3), a power source (e.g., a power source (11) of FIGS. 1 to 3) for supplying power to the heater, and a controller (e.g., the controller 12 of FIGS. 1 to 3) configured to control power supplied from the power source to the heater.

When the aerosol-generating device is of an induction heating type, the aerosol-generating device may further include an induction coil (e.g., the induction coil 181 of FIG. 3) surrounding the heater, and the heater may include a susceptor that generates heat by a magnetic field generated by the induction coil. However, the disclosure is not necessarily limited thereto. When the aerosol-generating device is of a resistance heating type, the aerosol-generating device may include only a resistance heater without an induction coil. In addition, the aerosol-generating device may employ the induction heating type and the resistance heating type together.

The aerosol-generating device may control power supplied from the power source to the heater such that the temperature of the heater is controlled based on the temperature profile. The aerosol-generating device may further include an insertion detection sensor for detecting insertion and/or removal of the aerosol-generating article. When the insertion of the aerosol-generating article is detected by the insertion detection sensor, the controller may start a heating operation of the heater according to the temperature profile. In other words, even though there is no separate user input, the aerosol-generating device may start the heating operation of the heater based on the detection of the insertion of the aerosol-generating article. However, the disclosure is not necessarily limited thereto. The aerosol-generating device may further include a user interface such as a button, and may start the heating operation of the heater based on an input received through the user interface.

The aerosol-generating device may preheat the aerosol-generating article before a smoking operation of a user involving a user puff is performed. The preheating period may correspond to a period of preparation for use before the smoking operation using the aerosol-generating device is performed. Accordingly, a sufficient amount of aerosols may be transferred from a first puff of the user. The aerosol-generating device may perform a preheating operation of the heater according to the preheating profile, and may notify a notification that preheating is completed when the preheating profile ends. When the preheating profile ends, the aerosol-generating device may perform the heating operation of the heater according to the smoking profile. The smoking period may correspond to a period in which a smoking operation using the aerosol-generating device is actually performed. The user may recognize that smoking preparation is completed through the notification, and may perform smoking accompanied by the user puff in the smoking period.

However, when the preheating profile only includes a temperature rising period, when a larger amount of aerosols than necessary is transferred at the beginning of smoking, the continuity of aerosol transfer may not be maintained at the end of smoking. Hereinafter, the preheating profile of the aerosol-generating device according to the present disclosure capable of maintaining an aerosol transfer amount as uniform as possible throughout the smoking will be described in detail with reference to the drawings.

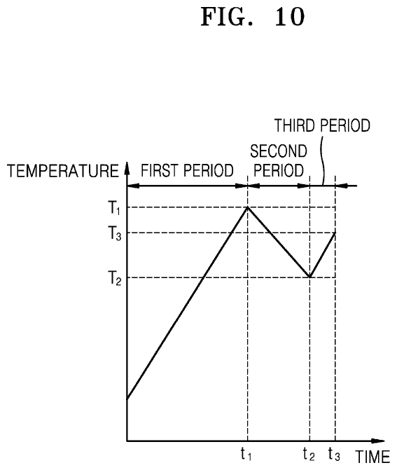

FIG. 10 is a diagram illustrating a preheating profile according to an embodiment of the present disclosure.

Referring to FIG. 10, the preheating profile according to an embodiment of the present disclosure may include a first period in which the temperature of a heater rises to a first temperature T₁, a second period in which the temperature of the heater drops to a second temperature T₂ lower than the first temperature T₁, and a third period in which the temperature of the heater rises again to a third temperature T₃ higher than the second temperature T₂. In FIG. 10, the third temperature T₃ is illustrated being lower than the first temperature T₁, but the disclosure is not limited thereto. The third temperature T₃ may be the same as the first temperature T₁.

The first temperature T₁ may correspond to a range value in which a certain margin is applied to a target temperature. For example, the first temperature T₁ may be a range value (i.e., 269° C. to 271° C.) obtained by applying a margin of ±1° C. to a target temperature of 270° C. The certain margin may be set in consideration of a control error. The aerosol-generating device performs temperature control so that the temperature of the heater reaches the target temperature by using a proportional integral derivative (PID) control in the first period, and the temperature that the heater actually reaches may not exactly match the target temperature.

For example, the aerosol-generating device may further include a temperature sensor for measuring the temperature of the heater, and a controller may determine a control parameter according to the PID control based on the temperature measured by the temperature sensor. In an embodiment, the control parameter may include a duty ratio of a pulse width modulation (PWM) signal for driving the heater. In the first period, because a difference between the current temperature of the heater and the target temperature is large, the duty ratio of the PWM signal may be determined as the maximum value. Therefore, the maximum value of the temperature that the heater actually reaches in the first period may vary according to the performance of the heater or a state of the aerosol-generating article. In other words, even though the target temperature is set to 270° C., the temperature of the heater may decrease after reaching 269° C., or the temperature of the heater may decrease after reaching 270.5° C. Thus, the first temperature T₁ may be set variably within an error range.

The controller may variably determine the second temperature T₂ and the third temperature T₃ based on the temperature that the heater actually reached in the first period. For example, the controller may determine the second temperature T₂ as a temperature obtained by subtracting a first value from the temperature that the heater actually reached in the first period, and determine the third temperature T₃ as a temperature obtained by adding a second value to the second temperature T₂. The first value and the second value may be fixed values. For example, in the case where the first value is 60° C. and the second value is 25° C., when the temperature that the heater actually reached in the first period is 270° C., the second temperature T₂ and the third temperature T₃ may be 210° C. and 235° C., respectively, and when the temperature that the heater actually reached in the first period is 271° C., the second temperature T₂ and the third temperature T₃ may be 211° C. and 236° C., respectively.

After an aerosol is generated in the first period, the aerosol generated in the first period may be condensed in the second period, and an aerosol may be generated again in the third period. In order to condense the aerosol in the second period, the second temperature T₂ may be set to a temperature at which no aerosol is generated from the aerosol-generating article. Here, the aerosol may refer to an aerosol corresponding to at least one aerosol-generating material included in the aerosol-generating article. For example, in order to prevent a nicotine aerosol from being generated, the second temperature T₂ may be set to a temperature lower than 247° C. which is a boiling point of nicotine. Preferably, the second temperature T₂ may be set to a temperature of 200° C. or less. In addition, the second temperature T₂ may be a temperature lower than all target temperatures set by the smoking profile starting when the preheating profile ends.

On the other hand, the controller may rise the temperature of the heater by using the PID control in the first period and the third period, and drop the temperature of the heater by cutting off the power supplied to the heater from the power source in the second period. In other words, the aerosol-generating device may apply different control methods to a temperature rising period and a temperature drop period. The controller may continuously monitor the temperature of the heater by using the temperature sensor even when power supply supplied to the heater is cut off in the second period. When the controller detects that the temperature of the heater has reached the second temperature T₂, the controller may start the third period in which the temperature of the heater rises again.

In the third period, as the condensed aerosol is transferred again with the generation of a new aerosol, an appropriate amount of aerosols may be generated at the beginning of smoking even though the third temperature T₃ is not higher than the first temperature T₁. In addition, the volume of heat transmitted to the aerosol-generating article is reduced due to the second period, and thus the aerosol transfer amount may be maintained uniformly until the end of smoking.

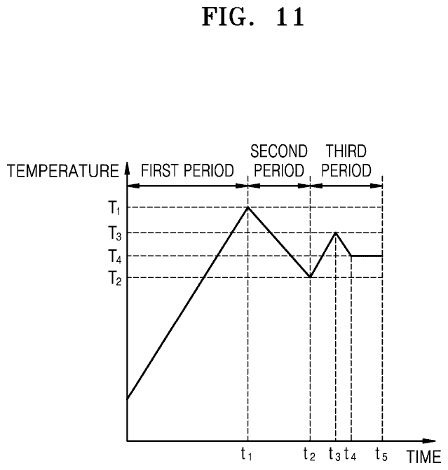

FIG. 11 is a diagram illustrating a preheating profile according to another embodiment of the present disclosure.

Referring to FIG. 11, the preheating profile according to another embodiment of the present disclosure may be the same as the preheating profile of FIG. 10, except that a third period is partially different.

The third period may further include a temperature drop period in which the temperature of a heater drops back to a fourth temperature T₄ after the temperature of the heater reaches the third temperature T₃, and a temperature maintenance period in which the temperature of the heater is maintained at the fourth temperature T₄. The third period further includes the temperature drop period and the temperature maintenance period, and thus a sufficient time for generating a sufficient amount of aerosols from an aerosol-generating article may be secured. A target temperature of the temperature maintenance period may be fixed regardless of the temperature that the heater actually reaches in a first period. In other words, unlike the first temperature T₁, the second temperature T₂, and the third temperature T₃ being variably determined according to the temperature that the heater actually reaches in the first period, the fourth temperature T₄ may have a fixed value. For example, the fourth temperature T₄ may be fixed at 215° C. However, the disclosure is not necessarily limited thereto.

On the other hand, in FIGS. 10 and 11, graphs of the temperature change of the heater over time includes straight lines, but this is only for convenience of illustration. As shown in FIG. 9, a graph of the measured temperature of the heater may include at least one curve.

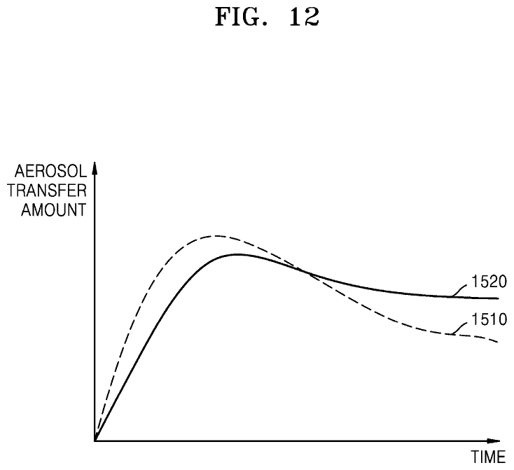

FIG. 12 is a diagram for explaining effects of a preheating profile according to embodiments of the present disclosure.

Referring to FIG. 12, a graph 1510 showing an aerosol transfer amount over time when the preheating profile includes only a temperature rising period and a graph 1520 showing an aerosol transfer amount over time when the preheating profile according to embodiments of the present disclosure is applied are shown.

Upon comparing the graph 1510 with the graph 1520, it may be seen that an aerosol-generating device according to the present disclosure employs the preheating profile including the temperature rising period, a temperature drop period, and a temperature re-rising period, and thus an excessive amount of aerosols is prevented from being transferred at the beginning of smoking and a similar level of an aerosol transfer amount to that at the beginning of smoking is maintained at the end of smoking.

The aerosol-generating device according to the present disclosure may achieve a uniform aerosol transfer throughout the smoking period while adjusting only the preheating profile corresponding to a preheating period much shorter than a smoking period. For example, as shown in FIG. 9, the aerosol-generating device according to the present disclosure may employ a stepwise drop profile in which the temperature of the heater drops step by step over time as a smoking profile, and the aerosol-generating device according to the present disclosure may achieve the uniform aerosol transfer throughout the smoking period simply by adjusting the preheating profile while maintaining the smoking profile. Therefore, the uniform aerosol transfer throughout the smoking period may be achieved while minimizing power consumption compared to adjusting the smoking profile corresponding to the smoking period (e.g., increasing the temperature of the heater at the latter half of the smoking period).

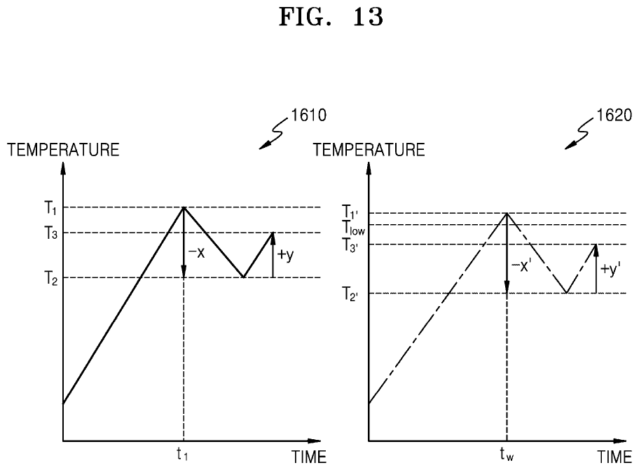

FIG. 13 is a diagram for explaining a method, performed by an aerosol-generating device, of adjusting preheating profiles according to an embodiment of the present disclosure.

Referring to FIG. 13, a preheating profile 1610 when an aerosol-generating article in a normal state is inserted into the aerosol-generating device and a preheating profile 1620 when an aerosol-generating article in an over-moisture state is inserted into the aerosol-generating device are shown.

The preheating profile 1610 may be the same as the preheating profile described with reference to FIG. 10. Referring to FIG. 10, the second temperature T₂ may be determined as a temperature obtained by subtracting the first value from the temperature that the heater actually reached in the first period, and the third temperature T₃ may be determined as a temperature obtained by adding the second value to the second temperature T₂. The first value and the second value for determining the second temperature T₂ and the third temperature T₃ may respectively correspond to x and y (x and y are positive real numbers, respectively).

On the other hand, when the aerosol-generating article is in the over-moisture state, even when the maximum power is supplied in the first period, the temperature of the heater may not reach the first temperature T₁ within a preset time t_{w}. In other words, even when the first temperature T₁ corresponds to a range value in which a certain margin is applied to a target temperature, the temperature of the heater may not reach a lower limit of the range value corresponding to the first temperature T₁. This is because when the aerosol-generating article is in the over-moisture state, its specific heat increases due to a high moisture content of the aerosol-generating article.

In the case where the aerosol-generating article is in the normal state, when an average duration of the first period is about 20 seconds, the preset time t_{w} for determining whether the aerosol-generating article is in the over-moisture state may be set to about 23 seconds. The average duration of the first period may mean an average time for the temperature of the heater to reach the first temperature T₁ in the first period.

Referring to the preheating profile 1620, when the temperature of the heater does not reach the first temperature T₁ within the preset time t_{w} in the first period, the controller may increase the first value and the second value. For example, the first value may increase from x to x′, and the second value may increase from y to y′. As both the first value and the second value increase, a temperature drop period corresponding to a second period and a temperature increase period corresponding to a third period may be longer. Accordingly, the temperature of a mainstream smoke may be reduced, and a sufficient amount of aerosols may be transferred from the beginning of smoking due to an increase in a preheating time.

Even when the aerosol-generated article is in the over-moisture state, a temperature T₁′ that the heater reaches in the first period of the preheating profile 1620 may be at least higher than a temperature lower limit T_{low}. When the temperature of the heater does not reach the temperature lower limit T_{low} even though the heater is heated to a first preset time (e.g., t_{w}) in the first period, a defect may occur in the aerosol-generating device. Therefore, when the temperature of the heater does not reach the temperature lower limit T_{low} by the first preset time in the first period, the controller may cut off power supplied from a power source to the heater. In addition, the controller may notify the occurrence of an error state by using an output unit (e.g., the output unit 14 of FIG. 1) that outputs information about the state of the aerosol-generating device.

To the contrary, the temperature of the heater may reach the first temperature T₁ within a too fast time in the first period. In this case, it may be determined that the heater is heated in a no-load state. When the temperature of the heater reaches the first temperature T₁ within a second preset time (about 11 seconds) in the first period, the controller may cut off power supplied from the power source to the heater. In addition, the controller may notify the occurrence of the error state by using the output unit.

Similar to the existence of a time threshold (e.g., t_{w}) related to the duration of the first period, a time threshold may also be set in each of the second period and the third period. For example, when the temperature of the heater does not drop to the second temperature T₂ or T₂′ by a third preset time (e.g., about 9 seconds) in the second period, the controller may stop a heating operation of the heater and control the output unit to notify the occurrence of the error state. In addition, because a threshold (e.g., about 40 seconds) of the total preheating time may exist, the time threshold of the third period may be variably determined based on a time (e.g., t₂) until the second period ends.

On the other hand, in addition to whether the aerosol-generating article is in the over-moisture state, the optimal preheating profile may be different according to an operation mode of the aerosol-generating device and/or a type of aerosol-generating article. Accordingly, the aerosol-generating device may adjust the preheating profile based on the operation mode of the aerosol-generating device and/or the type of aerosol-generating article.

For example, the aerosol-generating device may further include a button for receiving a user input or a sensor for identifying the type of aerosol-generating article. The user input received by the button may correspond to a mode selection or a type selection of the aerosol-generating article. The controller may adjust the first temperature T₁ based on a signal received from the button or the sensor. In addition, the first value and the second value may be set differently according to the operation mode of the aerosol-generating device and/or the type of the aerosol-generating article. Accordingly, the second temperature T₂ and the third temperature T₃ may also be appropriately adjusted. In addition, the fourth temperature T₄ may be set differently according to the operation mode of the aerosol-generating device and/or the type of aerosol-generating article.

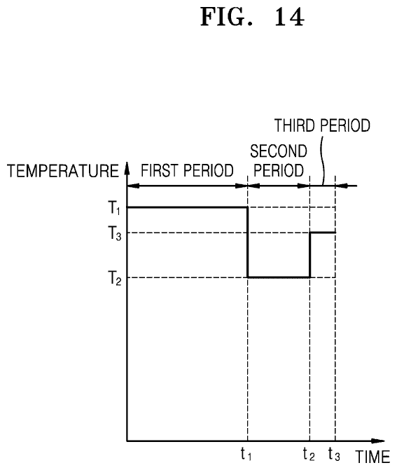

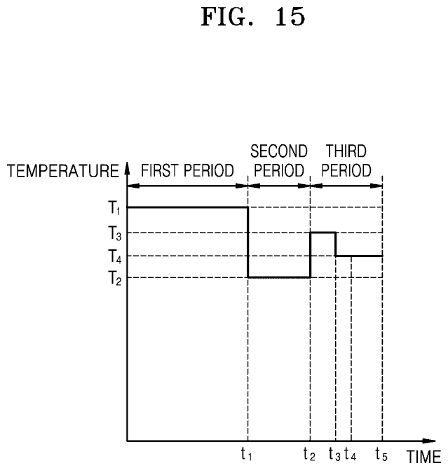

FIGS. 14 and 15 are diagrams illustrating target temperature profiles alternatively representing preheating profiles according to embodiments of the present disclosure.

Referring to FIG. 14, the target temperature profile alternatively representing the preheating profile of FIG. 10 is shown, and referring to FIG. 15, the target temperature profile alternatively representing the preheating profile of FIG. 11 is shown. When an aerosol-generating device controls the temperature of a heater according to the target temperature profiles shown in FIGS. 14 and 15, the preheating profiles shown in FIGS. 10 and 11 may be obtained.

In an embodiment, the first temperature T₁ may be appropriately selected in the range of 250° C. to 300° C., the second temperature T₂ may be appropriately selected in the range of 190° C. to 240° C., and the third temperature T₃ may be appropriately selected in the range of 220° C. to 270° C. However, the ranges of the first temperature T₁, the second temperature T₂ and the third temperature T₃ are not necessarily limited thereto. Referring to FIG. 11, the third period further includes the temperature drop period and the temperature maintenance period having the fourth temperature T₄ as a target temperature, but it may be considered that the preheating profile according to FIG. 15 includes four periods according to the target temperature.

The target temperature profiles shown in FIGS. 14 and 15 may be stored in a memory. The memory may be disposed separately from the controller but may be embedded in the controller. The memory may store a plurality of different target temperature profiles according to a state or a type of an aerosol-generating article and/or an operation mode of an aerosol-generating device.

Some embodiments or other embodiments of the disclosure described above are not exclusive or distinct from each other. In some embodiments or other embodiments of the disclosure described above, respective components or functions may be used in combination with one another or combined with one another.

For example, a component A described in a particular embodiment and/or drawing and a component B described in another embodiment and/or drawing may be combined with each other. In other words, even when coupling between components is not directly described, the coupling may be made except when the coupling is described as impossible.

The above description should not be construed as being limited in all respects but should be considered illustrative. The scope of the disclosure should be determined by the logical interpretation of appended claims, and all changes within the equivalent scope of the disclosure are included in the scope of the disclosure.

1. An aerosol-generating device comprising:
a heater configured to heat an aerosol-generating article;
a power source for supplying power to the heater; and
a controller configured to control power supplied from the power source to the heater so that a temperature of the heater is controlled based on a temperature profile,
wherein the temperature profile comprises a preheating profile and a smoking profile, and
the preheating profile comprises a first period in which the temperature of the heater rises to a first temperature, a second period in which the temperature of the heater drops to a second temperature lower than the first temperature, and a third period in which the temperature of the heater rises again to a third temperature higher than the second temperature.

2. The aerosol-generating device of claim 1, wherein
the first temperature corresponds to a range value in which a certain margin is applied to a target temperature, and
the controller is configured to
variably determine the second temperature and the third temperature based on a temperature that the heater actually reaches in the first period.

3. The aerosol-generating device of claim 2, wherein
the controller is configured to,
determine the second temperature as a temperature obtained by subtracting a first value from the temperature that the heater actually reaches in the first period, and
determine the third temperature as a temperature obtained by adding a second value to the second temperature.

4. The aerosol-generating device of claim 3, wherein
the controller is configured to
increase the first value and the second value when the temperature of the heater does not reach the first temperature within a first preset time in the first period.

5. The aerosol-generating device of claim 1, wherein
the second temperature corresponds to a temperature at which no aerosol is generated from the aerosol-generating article.

6. The aerosol-generating device of claim 1, wherein
the second temperature is a temperature lower than all target temperatures set by the smoking profile which starts when the preheating profile ends.

7. The aerosol-generating device of claim 1, wherein
the controller is configured to
rise the temperature of the heater by using a proportional integral derivative (PID) control in the first period and the third period, and
drop the temperature of the heater by cutting off the power supplied from the power source to the heater in the second period.

8. The aerosol-generating device of claim 7, further comprising:
a temperature sensor for measuring the temperature of the heater,
wherein the controller is configured to
determine a control parameter according to the PID control based on the temperature measured by the temperature sensor, and
the control parameter includes a duty ratio of a pulse width modulation (PWM) signal for driving the heater.

9. The aerosol-generating device of claim 1, wherein
the third period further includes a temperature drop period in which the temperature of the heater drops back to a fourth temperature after reaching the third temperature, and a temperature maintenance period in which the temperature of the heater is maintained at the fourth temperature.

10. The aerosol-generating device of claim 9, wherein
a target temperature of the temperature maintenance period is fixed regardless of the temperature that the heater actually reaches in the first period.

11. The aerosol-generating device of claim 1, wherein
the controller is configured to
cut off the power supplied from the power source to the heater when the temperature of the heater does not reach a temperature lower limit by a first preset time in the first period or when the temperature of the heater reaches the first temperature within a second preset time in the first period.

12. The aerosol-generating device of claim 1, further comprising:
an output unit configured to output information about a state of the aerosol-generating device,
wherein the controller is configured to
control the output unit to notify an occurrence of an error state when the temperature of the heater does not drop to the second temperature by a third preset time in the second period.

13. The aerosol-generating device of claim 1, further comprising:
a button for receiving a user input or a sensor for identifying a type of the aerosol-generating article,
wherein the controller is configured to
adjust the first temperature based on a signal received from the button or the sensor.

14. The aerosol-generating device of claim 1, further comprising:
an insertion detection sensor for detecting insertion and/or removal of the aerosol-generating article,
wherein the controller is configured to
start a heating operation of the heater according to the temperature profile when the insertion of the aerosol-generating article is detected by the insertion detection sensor.

15. The aerosol-generating device of claim 1, further comprising:
an induction coil surrounding the heater,
wherein the heater includes a susceptor generating heat by a magnetic field generated by the induction coil.
